(19) United States
(12) Patent Application Publication
(10) Pub. No.: US 2006/0132050 A1
(43) Pub. Date: Jun. 22, 2006

(54) Display device

(75) Inventors: Hidekazu Hatanaka, Suwon-si (KR); Seung-Hyun Son, Suwon-si (KR); Young-Mo Kim, Suwon-si (KR); Sung-Eui Lee, Suwon-si (KR); Ho-Nyeon Lee, Suwon-si (KR); Hyoung-Bin Park, Suwon-si (KR); Sang-Hun Jang, Suwon-si (KR); Gi-Young Kim, Suwon-si (KR)

Correspondence Address: H.C. PARK & ASSOCIATES, PLC, 8500 LEESBURG PIKE, SUITE 7500, VIENNA, VA, 22182, US

(73) Assignee: SAMSUNG SDI CO., LTD.

(21) Appl. No.: 11/284,969

(22) Filed: Nov. 23, 2005

(30) Foreign Application Priority Data
Dec. 18, 2004 (KR) 10-2004-0108412

(51) Int. Cl. G09G 3/10

(52) U.S. Cl. 315/169.1

(57) ABSTRACT

A display device uses electron accelerating layers in conjunction with electrodes at different voltages to emit electron beams with energy levels sufficient to excite a gas, which emits ultraviolet rays that in turn excite a light emitting layer to emit visible light. The use of electron accelerating layers makes it possible to excite the gas using a lower driving voltage and achieve improved luminous efficiency.

### CROSS-REFERENCE TO RELATED APPLICATION

This application claims priority to and the benefit of Korean Patent Application No. 10-2004-0108412, filed on Dec. 18, 2004, in the Korean Intellectual Property Office, the disclosure of which is incorporated herein in its entirety by reference.

### BACKGROUND OF THE INVENTION

1. Field of the Invention

The present invention relates to a display device with reduced driving voltage and increased luminous efficiency.

2. Discussion of the Background

Plasma display panels (PDPs) are a type of flat display device that display an image by the use of an electric discharge. PDPs enjoy wide popularity due to their exceptional brightness and wide viewing angle. PDPs emit visible light by a process where direct current (DC) or alternate current (AC) voltages are applied to electrodes with gas between them. The voltage difference excites the gas and causes it to emit ultraviolet rays. The ultraviolet rays in turn excite a phosphor material and cause it to emit visible light.

The two most common PDP electrode structures are the facing discharge structure and the surface discharge structure. In the facing discharge structure, a pair of sustain electrodes are disposed on an upper substrate and a lower substrate, respectively, and a discharge is generated perpendicular to the substrate. In the surface discharge structure, a pair of sustain electrodes are disposed on the same substrate and a discharge is generated parallel to the substrate.

FIG. 1 shows an exploded perspective view of a conventional AC surface discharge PDP. FIG. 2A and FIG. 2B are cross-sectional views along horizontal and vertical lines of FIG. 1.

Referring to FIG. 1, FIG. 2A, and FIG. 2B, a lower substrate 10 and an upper substrate 20 are arranged opposite each other with a discharge space between them. A plurality of address electrodes 11 are formed on the lower substrate 10 and are covered by a first dielectric layer 12. A plurality of barrier ribs 13 are formed on an upper surface of the first dielectric layer 12. The barrier ribs 13 divide the discharge space to define a plurality of discharge cells 14 and to prevent electrical and optical cross-talk between the cells 14. Red, green, and blue phosphor layers 15 are coated on the inner walls of the cells 14. A discharge gas that may include Xe fills the cells 14.

The upper substrate 20 is transparent and is coupled to the lower substrate 10. A pair of sustain electrodes 21a and 21b are formed perpendicular to the address electrodes 11 on is the lower surface of the upper substrate 20 of each cell 14. The sustain electrodes 21a and 21b may be formed of a conductive material that is also capable of transmitting visible light, such as indium tin oxide (ITO). Narrow bus electrodes 22a and 22b are formed of metal on the lower surface of the sustain electrodes 21a and 21b to reduce the line resistance of the sustain electrodes 21a and 21b. The sustain electrodes 21a and 21b and the bus electrodes 22a and 22b are covered by a transparent second dielectric layer 23. A protection layer 24 is formed of MgO on the lower surface of the second dielectric layer 23. The protection layer 24 prevents damage to the second dielectric layer 23 by sputtering plasma particles and reduces the required discharge voltage by emitting secondary electrons.

An address discharge and a sustain discharge must be generated to drive the PDP. The address discharge occurs between the address electrode 11 and one of the pair of the sustain electrodes 21a and 21b. The sustain discharge is caused by a potential difference between the pair of sustain electrodes 21a and 21b and excites the discharge gas, which emits ultraviolet rays that in turn excite a phosphor layer 15 that generates visible light. The visible light is emitted through the upper substrate and forms the image displayed by the PDP.

Plasma discharge can also be used in a flat lamp to produce a back-light for a liquid crystal display (LCD). FIG. 3 shows a perspective view of a conventional flat lamp that has an AC voltage surface discharge structure.

Referring to FIG. 3, a lower substrate 50 and an upper substrate 60 are arranged opposite each other with a constant distance between them formed by spacers 53. Plasma discharge occurs in the plasma discharge space between the lower substrate 50 and the upper substrate 60. A plurality of spacers 53 are formed between the lower substrate 50 and the upper substrate 60 to divide the discharge space into a plurality of discharge cells 54 and to maintain a constant distance between the lower substrate 50 and the upper substrate 60. Discharge gas that may include Xe fills the discharge cells. The discharge gas emits ultraviolet rays that excite phosphor layers 55 coated on the inner walls of the discharge cells 54 to generate visible light.

Discharge electrodes for generating plasma discharge in each discharge cell are formed on the lower substrate 50 and the upper substrate 60. A first lower electrode 51a and a second lower electrode 51b are formed on the lower surface of the lower substrate 50 in each discharge cell 54. A first upper electrode 61a and a second upper electrode 61b are formed on the upper surface of the upper substrate 60 in each discharge cell 54. Discharge does not occur between the first lower electrode 51a and the first upper electrode 61a, or between the second lower electrode 51b and the second upper electrode 61b because they are at the same potential. A surface discharge occurs parallel to the lower substrate 50 and the upper substrate 60 because there is a potential difference between the first lower electrode 51a and the second lower electrode 51b and between the first upper electrode 61a and second upper electrode 61b.

A major drawback of a conventional plasma display panel and flat lamp is that they require a large amount of energy to ionize the discharge gas to generate ultraviolet rays. Because of this, the conventional plasma display panel and the flat lamp require a high driving voltage and have a low luminous efficiency.

### SUMMARY OF THE INVENTION

The present invention provides a display device that uses electron accelerating layers in conjunction with electrodes at different voltages to emit electron beams with energy levels sufficient to excite a gas, which emits ultraviolet rays that in turn excite a light emitting layer to emit visible light. The use of electron accelerating layers makes it possible to excite the gas using a lower driving voltage and achieve an improved luminous efficiency than can be achieved by conventional display devices.

Additional features of the invention will be set forth in the description which follows, and in part will be apparent from the description, or may be learned by practice of the invention.

The present invention discloses a display device that includes a first substrate and a second substrate opposing each other and having a space between them, a cell positioned between the first substrate and the second substrate, a first electrode positioned to correspond to the cell, a second electrode positioned to correspond to the cell, a first electron accelerating layer positioned on the first electrode and being capable of emitting a first electron beam into the cell, a gas inside the cell and being capable of generating ultraviolet rays when excited by the first electron beam, and a light emitting layer positioned inside the cell and being capable of generating visible light when excited by the ultraviolet rays.

It is to be understood that both the foregoing general description and the following detailed description are exemplary and explanatory and are intended to provide further explanation of the invention as claimed.

### BRIEF DESCRIPTION OF THE DRAWINGS

The accompanying drawings, which are included to provide a further understanding of the invention and are incorporated in and constitute a part of this specification, illustrate embodiments of the invention, and together with the description serve to explain the principles of the invention.

FIG. 1 shows an exploded perspective view of a conventional PDP.

FIG. 2A and FIG. 2B show cross-sectional views along horizontal and vertical lines of FIG. 1, respectively.

FIG. 3 shows a perspective view of a conventional flat lamp.

FIG. 4 shows a cross-sectional view of a flat display device according to a first exemplary embodiment of the present invention.

FIG. 5 shows a graph of energy levels of Xe.

FIG. 6A, FIG. 6B, FIG. 6C, and FIG. 6D show waveforms that can be applied to the electrodes in the flat display device according to the first exemplary embodiment of the present invention.

FIG. 7 shows a cross-sectional view of a modified version of a flat display device according to a first exemplary embodiment of the present invention.

FIG. 8 shows a cross-sectional view of a flat display device according to a second exemplary embodiment of the present invention.

FIG. 9A and FIG. 9B show waveforms that can be applied to the electrodes in the flat display device according to the second exemplary embodiment of the present invention.

FIG. 10 shows a cross-sectional view of a flat display device according to a third exemplary embodiment of the present invention.

FIG. 11 shows a cross-sectional view of a flat display device according to a fourth exemplary embodiment of the present invention.

FIG. 12 shows a cross-sectional view of a flat lamp according to a fifth exemplary embodiment of the present invention.

FIG. 13 shows a cross-sectional view of a flat lamp according to a sixth exemplary embodiment of the present invention.

FIG. 14 shows a cross-sectional view of a flat lamp according to a seventh exemplary embodiment of the present invention.

FIG. 15 shows a cross-sectional view of a flat lamp according to an eighth exemplary embodiment of the present invention.

FIG. 16 shows a cross-sectional view of a flat lamp according to a ninth exemplary embodiment of the present invention.

FIG. 17 shows a cross-sectional view of a flat lamp according to a tenth exemplary embodiment of the present invention.

FIG. 18 shows a cross-sectional view of a flat display device according to an eleventh exemplary embodiment of the present invention.

### DETAILED DESCRIPTION OF THE ILLUSTRATED EMBODIMENTS

The invention is described more fully hereinafter with reference to the accompanying drawings, in which embodiments of the invention are shown. This invention may, however, be embodied in many different forms and should not be construed as limited to the embodiments set forth herein. Rather, these embodiments are provided so that this disclosure is thorough, and will fully convey the scope of the invention to those skilled in the art. Flat display devices and flat lamps are described as the exemplary display devices according to the present invention, but the present invention is not limited thereto. In the drawings, the size and relative sizes of layers and regions may be exaggerated for clarity.

It will be understood that when an element such as a layer, film, region or substrate is referred to as being “on” another element, it can be directly on the other element or intervening elements may also be present. In contrast, when an element is referred to as being “directly on” another element, there are no intervening elements present.

FIG. 4 shows a cross-sectional view of a flat display device according to a first exemplary embodiment of the present invention.

Referring to FIG. 4, a first substrate 110 serves as a lower substrate, and a second substrate 120 serves as an upper substrate. Alternatively, the first substrate 110 may be the upper substrate, and the second substrate 120 may be the lower substrate. The first substrate 110 and the second substrate 120 are arranged opposite each other with a constant distance between them. The first substrate 110 and the second substrate 120 may be formed of transparent glass.

A plurality of barrier ribs 113 are formed between the first substrate 110 and the second substrate 120 to form a plurality of cells 114 and prevent electrical and optical cross-talk between the cells 114. Red, green, and blue light emitting layers 115 may be coated on the inner walls of the cells 114. Depending on the material used, the light emitting layers 115 generate visible light when excited by either UV rays or electrons. A gas that may include Xe fills the cells 114. The gas may be a discharge gas that generates ultraviolet rays when excited by external energy such as an electron beam.

A first electrode 131 is formed in each cell 114 on the upper surface of the first substrate 110, and a second electrode 132 is formed in each cell 114 on the lower surface of the second substrate 120 to cross the first electrode 131. In this exemplary embodiment, the first electrode 131 and the second electrode 132 are a cathode electrode and an anode electrode, respectively. The second electrode 132 may be formed of a transparent conductive material such as ITO to transmit visible light. A dielectric layer (not shown) may be formed on the second electrode 132.

An electron accelerating layer 140 is formed on the upper surface of the first electrode 131. A third electrode 133, which is a grid electrode, is formed on the electron accelerating layer 140. The electron accelerating layer 140 may be formed of any material that can generate an electron beam (E-beam) by accelerating electrons. One example of such a material is oxidized porous silicon. The oxidized porous silicon may be, for example, oxidized porous poly silicon or oxidized porous amorphous silicon.

The electron accelerating layer 140 emits an E-beam into the cell 114 through the third electrode 133 by accelerating electrons flowing from the first electrode 131 when a voltage is applied to the first electrode 131 and the third electrode 133 (and/or the second electrode 132). The E-beam excites the gas, which generates ultraviolet rays while stabilizing. The ultraviolet rays in turn excite the light emitting layer 115, which generates visible light to form an image when the light passes through the second substrate 120.

The E-beam may have an energy higher than the energy required to excite the gas but lower than the energy required to ionize the gas. The voltage needed for the optimal electron energy to excite the gas is applied to the first electrode 131 and the third electrode 133 (and/or the second electrode 132).

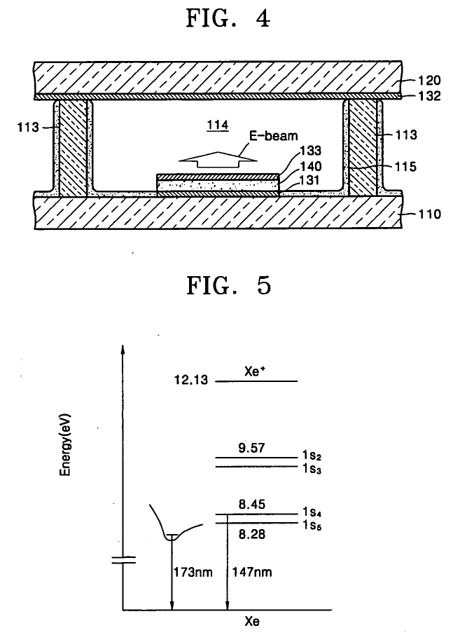

FIG. 5 shows a graph of energy levels of Xe. Xe may be used as the discharge gas to generate ultraviolet rays.

Referring to FIG. 5, 12.12 eV of energy is required to ionize Xe, and more than 8.28 eV is required to excite Xe. 8.28 eV, 8.45 eV, and 9.57 eV are required to excite Xe to 1S₅, 1S₄, and 1S₂ states, respectively. The excited Xe* generates ultraviolet rays with a wavelength of about 147 nm while stabilizing. Excimer Xe₂* is generated by colliding the excited Xe* with Xe in a grounded state. The Xe₂* generates ultraviolet rays of about 173 nm while stabilizing.

Accordingly, in the present invention, an E-beam emitted into a cell 114 by the electron accelerating layer 140 may have an energy of about 8.28 eV to about 12.13 eV, preferably about 8.28 eV to about 9.57 eV, and more preferably about 8.28 to about 8.45. Alternatively, the E-beam may have an energy of about 8.45 eV to about 9.57 eV.

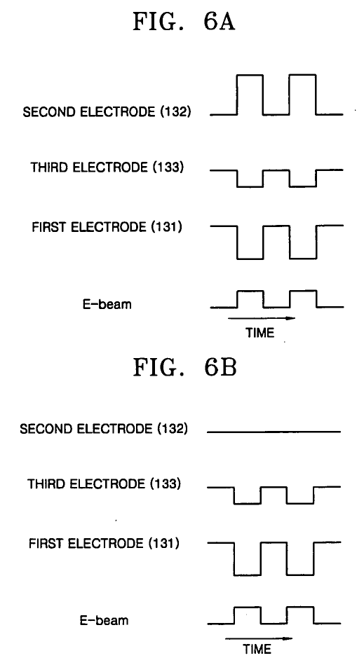

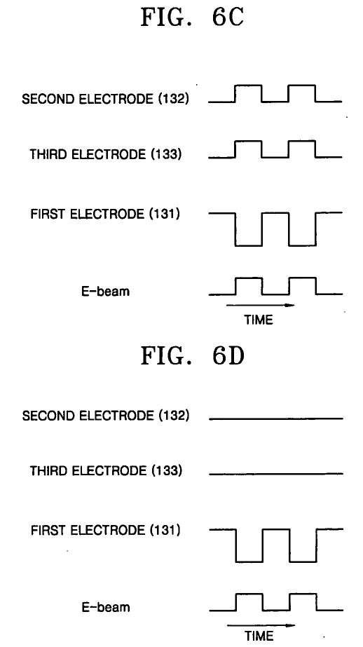

FIG. 6A, FIG. 6B, FIG. 6C, and FIG. 6D show waveforms that may be applied to the electrodes in the flat display device of FIG. 4.

Referring to FIG. 6A, different pulse voltages are applied to the first electrode 131, the second electrode 132, and the third electrode 133. When V₁, V₂, and V₃ represent the voltages applied respectively to the first electrode 131, the second electrode 132, and the third electrode 133, then V₁<V₃<V₂.

An E-beam is emitted into the cell 114 through the electron accelerating layer 140 by the voltages applied to the first electrode 131 and the third electrode 133. The emitted E-beam is accelerated toward the second electrode 132 by the voltages applied to the third electrode 133 and the second electrode 132. The gas is excited by this process. The gas can be controlled to a discharge state by adjusting the voltage of the second electrode 132. Alternatively, the second electrode 132 can be grounded, as depicted in FIG. 6B. If the second electrode is grounded, electrons arriving at the second electrode 132 can be discharged to the outside.

Referring to FIG. 6C, if the voltages applied to the first electrode 131, the second electrode 132, and the third electrode 133 are respectively V₁, V₂, and V₃, then V₁<V₃=V₂. When the above voltages are applied to the electrodes, an E-beam is emitted into the cell 114 through the electron accelerating layer 140 by the voltages applied to the first electrode 131 and the third electrode 133. Alternatively, the second electrode 132 and the third electrode 133 can be grounded, as depicted in FIG. 6D. If the second and third electrons are grounded, electrons arriving at the second electrode 132 can be discharged to the outside.

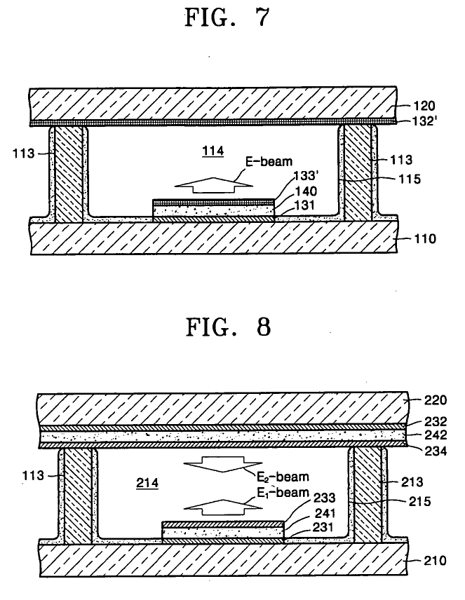

FIG. 7 shows a cross-sectional view of a modified version of a flat display device according to a first exemplary embodiment of the present invention.

Referring to FIG. 7, the second electrode 132′ is formed in a mesh structure so that visible light generated from the cells 114 can be transmitted. The third electrode 133′ is also formed in a mesh structure so that electrons accelerated by the electron accelerating layer 140 can readily be emitted into the cells 114.

FIG. 8 shows a cross-sectional view of a flat display device according to a second exemplary embodiment of the present invention.

Referring to FIG. 8, a first substrate 210 and a second substrate 220 are arranged opposite each other with a constant distance between them. A plurality of barrier ribs 213 are formed between the first substrate 210 and the second substrate 220 to define a plurality of cells 214. Red, green, and blue light emitting layers 215 are coated on the inner walls of the cells 214, and a gas that may include Xe fills the cells 214.

A first electrode 231 is formed on the upper surface of the first substrate 210 in each cell 214, and a second electrode 232 is formed on the lower surface of the second substrate 220 in each cell 214 to cross the first electrode 231. A first electron accelerating layer 241 and a second electron accelerating layer 242 are formed on the first electrode 231 and the second electrode 232, respectively. A third electrode 233 and a fourth electrode 234 are formed on the first electron accelerating layer 241 and the second electron accelerating layer 242, respectively. The first electron accelerating layer 241 and the second electron accelerating layer 242 may be formed of any material that can generate an electron beam by accelerating electrons, such as oxidized porous silicon. The oxidized porous silicon may be, for example, oxidized porous polysilicon or oxidized porous amorphous silicon.

When a voltage is applied to the first electrode 231 and the third electrode 233 (and/or the second electrode 232), electrons flow through the first electrode 231 to the first electron accelerating layer 241. The first electron accelerating layer 241 accelerates the electrons to emit a first electron beam E₁-beam into the cell 214 through the third electrode 233. When a voltage is applied to the second electrode 232 and the fourth electrode 234 (and/or the first electrode 231), the second electron accelerating layer 242 accelerates electrons flowing in from the second electrode 232 and emits a second electron beam E₂-beam into the cell 214 through the fourth electrode 234. The alternating current causes the first electron accelerating layer 241 and the second electron accelerating layer 242 to alternately emit electron beams into the cell 214. The first and second electron beams excite the gas, which in turn generates ultraviolet rays that excite the light emitting layer 215. The first and second electron beams may have an energy greater than the energy required to excite the gas but less than the energy required to ionize the gas.

The second electrode 232 and the fourth electrode 234 may be formed of a transparent conductive material such as ITO to transmit visible light. The third electrode 233 and the fourth electrode 234 may be formed in a mesh structure so that electrons accelerated by the first and second electron accelerating layers 241 and 242 can be readily emitted into the cell 214. A plurality of address electrodes (not shown) may be formed on either the first substrate 210 or the second substrate 220.

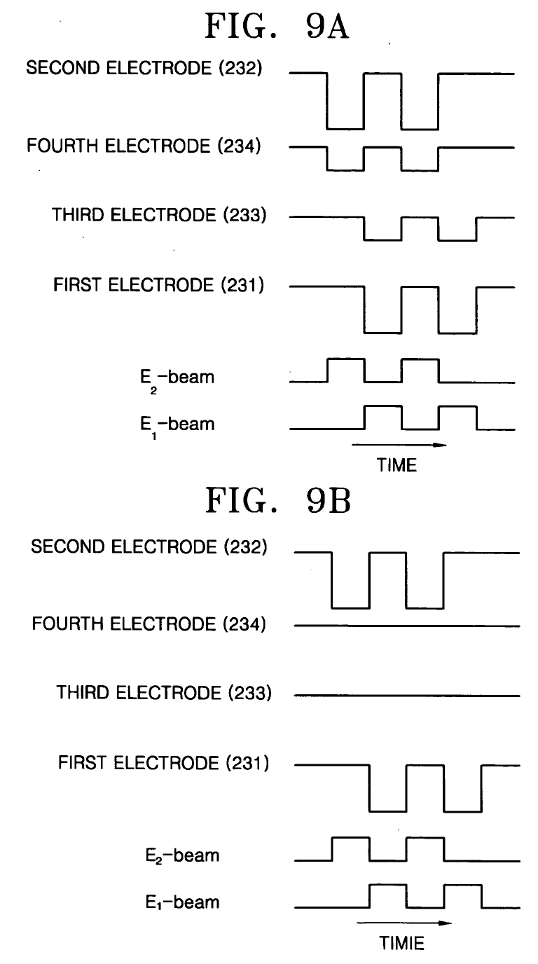

FIGS. 9A and 9B show voltage waveforms that can be applied to the electrodes in the flat display device according to the second exemplary embodiment of the present invention.

Referring to FIG. 9A, different pulse voltages are applied to each of the first electrode 231, the second electrode 232, the third electrode 233, and the fourth electrode 234. If the voltages applied to the first electrode 231, the second electrode 232, the third electrode 233, and the fourth electrode 234 are respectively V₁, V₂, V₃, and V₄, then V₁<V₃ and V₂<V₄. When the above voltages are applied to the electrodes, a first electron beam E₁-beam is emitted into the cell 214 through the first electron accelerating layer 241 due to the voltages applied to the first electrode 231 and the third electrode 233 (and/or the second electrode 232), and a second electron beam E₂-beam is emitted into the cell 214 through the second electron accelerating layer 242 due to the voltages applied to the second electrode 232, and the fourth electrode 234 (and/or the first electrode 231). The alternating current is applied between the first electrode 231 and the second electrode 232, which causes the first and second electron beams to be alternately emitted into the cell 214. As depicted in FIG. 9B, the third electrode 233 and the fourth electrode 234 can be grounded.

FIG. 10 shows a cross-sectional view of a flat display device according to a third exemplary embodiment of the present invention.

Referring to FIG. 10, a first substrate 310 and a second substrate 320 are arranged opposite each other with a constant distance between them. A plurality of cells 314 are formed between the first substrate 310 and second substrate 320. A plurality of address electrodes 311 are formed on the upper surface of the first substrate 310. A dielectric layer 312 covers the address electrodes 311. Red, green, and blue light emitting layers 315 are coated on the inner walls of the cells 314, and a gas that may include Xe fills the cells 314.

A first electrode 331 and a second electrode 332 are formed between the first substrate 310 and the second substrate 320 in each cell 314. In this exemplary embodiement, the first electrode 331 and the second electrode 332 are located on either side of the cell 314. The first electron accelerating layer 341 and the second electron accelerating layer 342 are formed on the inner surface of the first electrode 331 and the second electrode 332, respectively. The third electrode 333 and the fourth electrode 334 are formed on the first electron accelerating layer 341 and the second electron accelerating layer 342, respectively. The first electron accelerating layer 341 and the second electron accelerating layer 342 may be formed of any material that can generate an electron beam by accelerating electrons, such as oxidized porous silicon. The oxidized porous silicon may be, for example, oxidized porous polysilicon or oxidized porous amorphous silicon.

When a voltage is applied to the first electrode 331 and the third electrode 333 (and/or the second electrode 332), the first electron accelerating layer 341 emits a first electron beam E₁-beam into the cell 314. When a voltage is applied to the second electrode 332 and the fourth electrode 334 (and/or the first electrode 331), the second electron accelerating layer 342 emits a second electron beam E₂-beam into the cell 314. An alternating current is applied between the first electrode 331 and the second electrode 332, which causes the first and second electron beams to be alternately emitted into the cell 314. The first and second electron beams excite the gas, which generates ultraviolet rays that in turn excite a light emitting layer 315. The first and second electron beams may have an energy greater than the energy required to excite the gas but less than the energy required to ionize the gas.

The third electrode 333 and the fourth electrode 334 may be formed in a mesh structure so that electrons accelerated by the first electron accelerating layer 341 and the second electron accelerating layer 342 can be readily emitted into the cell 314. The first electron accelerating layer 341 and the second electron accelerating layer 342 may serve to form the cells 314 by defining a space between the first substrate 310 and the second substrate 320. A plurality of barrier ribs (not shown) may further be formed between the first substrate 310 and the second substrate 320 to define the cells 314.

The voltage waveforms shown in FIG. 9A and FIG. 9B can be applied to the electrodes of the flat display device shown in FIG. 10 in the same manner as described above.

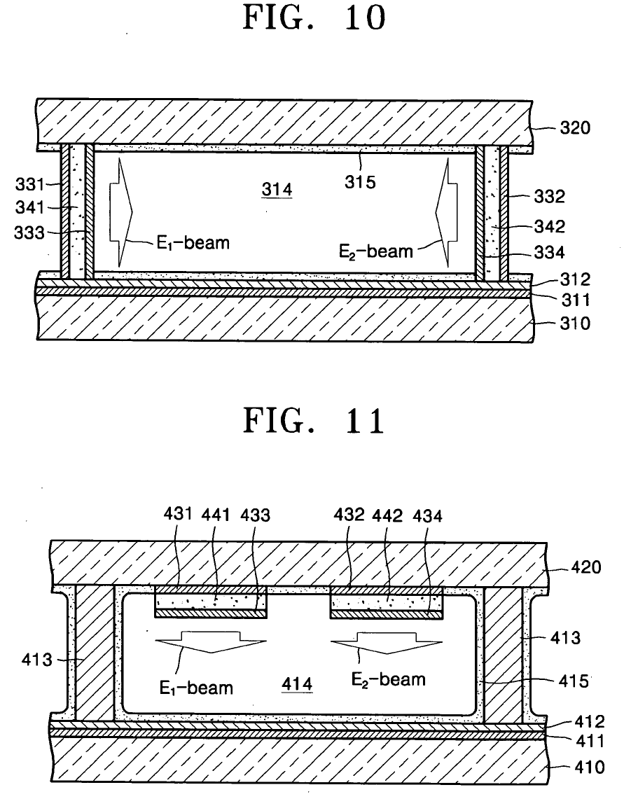

FIG. 11 shows a cross-sectional view of a flat display device according to a fourth exemplary embodiment of the present invention.

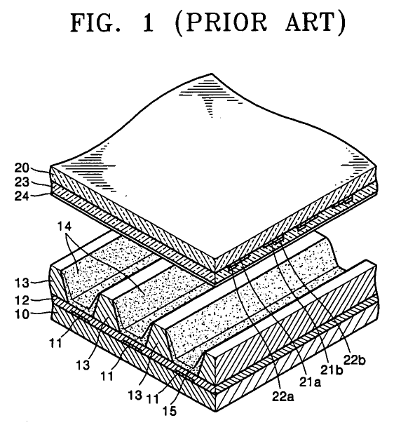

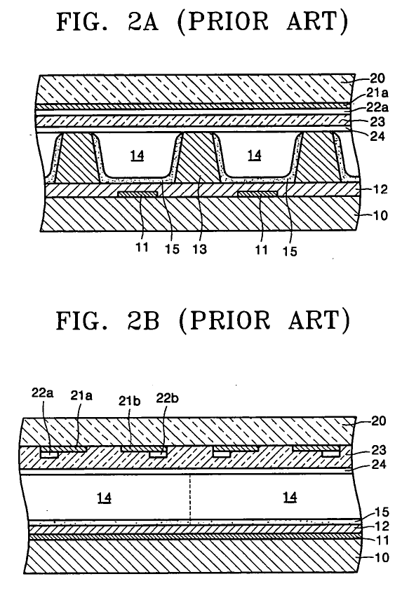

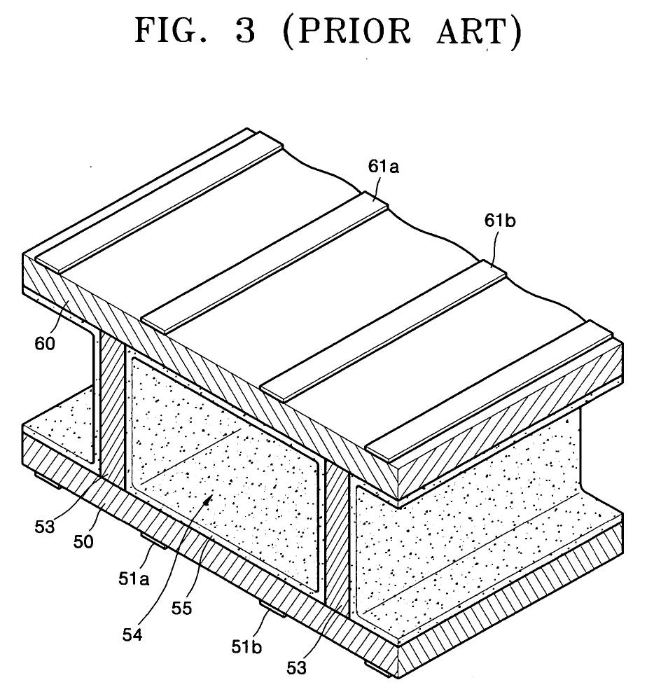

Referring to FIG. 1, a first substrate 410 serves as a lower substrate, and a second substrate 420 serves as an upper substrate. Alternatively, the first substrate 410 may be the upper substrate and the second substrate 420 may be the lower substrate. The first substrate 410 and the second substrate 420 are arranged opposite each other with a constant distance between them. A plurality of barrier ribs 413 are formed between the first substrate 410 and the second substrate 420 define a plurality of cells 414. Red, green, and blue light emitting layers 415 are coated on the inner walls of the cells 414. A gas that includes Xe fills the cells 414.

A plurality of address electrodes 411 are formed on the upper surface of the first substrate 410. The address electrodes 411 are covered by a dielectric layer 412. A first electrode 431 and a second electrode 432 are formed on the lower surface of the second substrate 420 in each cell 414. The first electrode 431 and the second electrode 432 are formed to cross the address electrodes 411. A first electron accelerating layer 441 and a second electron accelerating layer 442 are formed on the lower surfaces of the first electrode 431 and the second electrode 432, respectively. A third electrode 433 and a fourth electrode 434 are formed on the lower surfaces of the first electron accelerating layer 441 and the second electron accelerating layer 442, respectively. The first electron accelerating layer 441 and the second electron accelerating layer 442 may be formed of any material that can generate an electron beam by accelerating electrons, such as oxidized porous silicon. The oxidized porous silicon may be, for example, oxidized porous polysilicon or oxidized porous amorphous silicon.

When a voltage is applied to the first electrode 431 and the third electrode 433 (and/or the second electrode 432), the first electron accelerating layer 441 emits a first electron beam E₁-beam into the cell 414. When a voltage is applied to the second electrode 432 and the fourth electrode 434 (and/or the first electrode 431), the second electron accelerating layer 442 emits a second electron beam E₂-beam into the cell 414. An alternating current applied between the first electrode 431 and the second electrode 432 causes the first electron beam and the second electron beam to be alternately emitted into the cell 414. The first electron beam and the second electron beam excite the gas, which generates ultraviolet rays that in turn excite a light emitting layer 415. The first electron beam and the second electron beam may have an energy greater than the energy required to excite the gas but less than the energy required to ionize the gas.

The first electrode 413, second electrode 432, third electrode 433, and fourth electrode 434 may be formed of a transparent conductive material such as ITO to transmit visible light. The third electrode 433 and the fourth electrode 434 may be formed in a mesh structure so that electrons accelerated by the first electron accelerating layer 441 and the second electron accelerating layer 442 can be readily emitted into the cell 414.

The voltage waveforms shown in FIG. 9A and FIG. 9B may be applied to the electrodes of the flat display device shown in FIG. 11 in the same manner as described above.

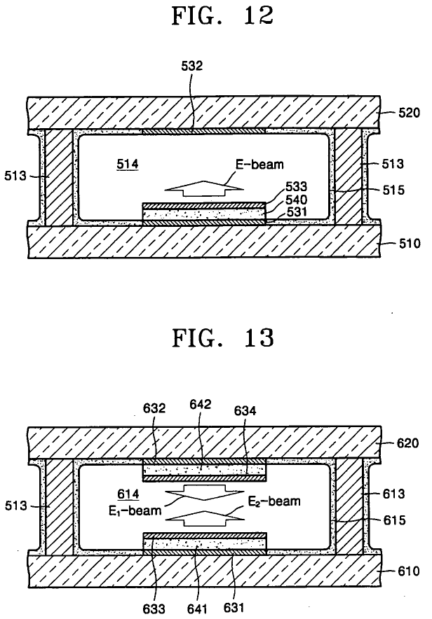

FIG. 12 shows a cross-sectional view of a flat lamp according to a fifth embodiment of the present invention. The flat lamp may be used as a backlight of an LCD.

Referring to FIG. 12, a first substrate 510 serves as a lower substrate, and a second substrate 520 serves as an upper substrate. Alternatively, the first substrate 510 may be the upper substrate and the second substrate 520 may be the lower substrate. The first substrate 510 and the second substrate 520 are arranged opposite each other with a constant distance between them. At least one cell 514 is formed between the first substrate 510 and the second substrate 520. The first substrate 510 and the second substrate 520 may be formed of transparent glass. Spacers 513 may be formed between the first substrate 510 and the second substrate 520 to define at least one cell 514. Light emitting layers 515 are coated on the inner walls of the cell 514, and a gas that may include Xe fills the cell 514.

A first electrode 531 is formed on the upper surface of the first substrate 510 in each cell 514, and a second electrode 532 is formed on the lower surface of the second substrate 520 in each cell 514 parallel to the first electrode 531. The first electrode 531 and the second electrode 532 are a cathode electrode and an anode electrode, respectively. The second electrode 532 may be formed of a transparent conductive material such as ITO for transmitting visible light, and may be formed in a mesh structure.

An electron accelerating layer 540 is formed on the upper surface of the first electrode 531, and a third electrode 533, which is a grid electrode, is formed on the upper surface of the electron accelerating layer 540. The electron accelerating layer 540 may be formed of any material that can generate an electron beam by accelerating electrons, such as oxidized porous silicon. The oxidized porous silicon may be, for example, oxidized porous polysilicon or oxidized porous amorphous silicon.

When a voltage is applied to the first electrode 531 and the third electrode 533 (and/or the second electrode 532), the electron accelerating layer 540 emits an electron beam E-beam into the cell 514 through the third electrode 533 by accelerating electrons flowing from the is first electrode 531. The electron beam emitted into the cell 514 excites a gas, which generates ultraviolet rays. The ultraviolet rays in turn excite the light emitting layers 515, which emit visible light toward the second substrate 520. The third electrode 533 may be formed in a mesh structure so that electrons accelerated by the electron accelerating layer 540 can be readily emitted into the cell 514. The electron beam may have an energy greater than the energy required to excite the gas but less than the energy required to ionize the gas.

The waveforms shown in FIG. 6A, FIG. 6B, FIG. 6C and FIG. 6D can be applied to the electrodes of the flat lamp shown in FIG. 12 in the same manner as described above.

FIG. 13 shows a cross-sectional view of a flat lamp according to a sixth exemplary embodiment of the present invention.

Referring to FIG. 13, a first substrate 610 and a second substrate 620 are arranged opposite each other with a constant distance between them. At least one cell 614 is formed between them. Spacers 613 may be formed between the first substrate 610 and the second substrate 620 to define at least one cell 614. Light emitting layers 615 are coated on the inner walls of the cell 614, and a gas that may include Xe fills the cell 614.

A first electrode 631 is formed on the upper surface of the first substrate 610 in each cell 614, and a second electrode 632 is formed on the lower surface of the second substrate 620 in each cell 614 parallel to the first electrode 631. A first electron accelerating layer 641 and a second electron accelerating layer 642 are formed on the first electrode 631 and the second electrode 632, respectively. A third electrode 633 and a fourth electrode 634 are formed on the first electron accelerating layer 641 and the second electron accelerating layer 642, respectively. The first electrode accelerating layer 641 and the second electron accelerating layer 642 may be formed of any material that can generate an electron beam by accelerating electrons, such as oxidized porous silicon. The oxidized porous silicon may be, for example, oxidized porous polysilicon or oxidized porous amorphous silicon.

When a voltage is applied to the first electrode 631 and the third electrode 633 (and/or the second electrode 632), the first electron accelerating layer 641 emits a first electron beam E₁-beam into the cell 614 through the third electrode 633 by accelerating electrons that enter through the first electrode 631. When a voltage is applied to the second electrode 632 and the fourth electrode 634 (and/or the first electrode 631), the second electron accelerating layer 642 emits a second electron beam E₂-beam into the cell 614 through the fourth electrode 634 by accelerating electrons that enter through the second electrode 632. An alternating current applied between the first electrode 631 and the second electrode 632 causes the first electron beam and the second electron beam to be alternately emitted into the cell 614. The first electron beam and the second electron beam excite the gas, which generates ultraviolet rays that in turn excite a light emitting layer 615. The first electron beam and the second electron beam may have an energy greater than the energy required to excite the gas but less than the energy required to ionize the gas.

The second electrode 632 and the fourth electrode 634 may be formed of a transparent conductive material such as ITO to transmit visible light. The third electrode 633 and the fourth electrode 634 may be formed in a mesh structure so that electrons accelerated by the first electron accelerating layer 641 and the second electron accelerating layer 642 can be readily emitted into the cells 614.

The voltage waveforms shown in FIGS. 9A and 9B can be applied to the electrodes of the flat lamp shown in FIG. 13 in the same manner as described above.

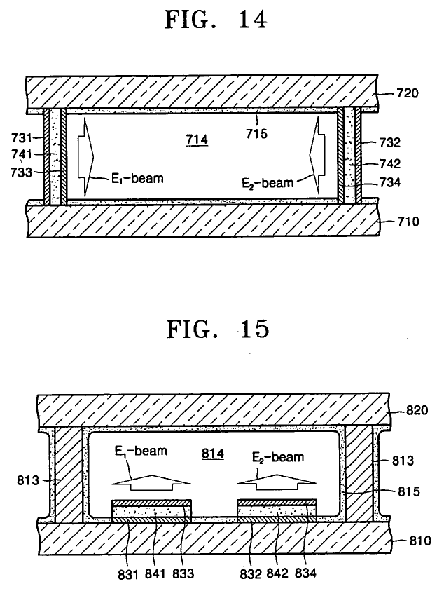

FIG. 14 shows a cross-sectional view of a flat lamp according to a seventh exemplary embodiment of the present invention.

Referring to FIG. 14, a first substrate 710 and a second substrate 720 are arranged opposite each other to define at least one cell 714 between them. Light emitting layers 715 are coated on the inner walls of the cell 714, and a gas that includes Xe fills the cell 614.

A first electrode 731 and a second electrode 732 are formed between the first substrate 710 and the second substrate 720 in each cell 714. The first electrode 731 and the second electrode 732 are located on either side of the cell 714. A first electron accelerating layer 741 and a second electron accelerating layer 742 are formed on the inner walls of the first electrode 731 and the second electrode 732, respectively. A third electrode 733 and a fourth electrode 734 are formed on the first electron accelerating layer 741 and the second electron accelerating layer 742, respectively. The first electron accelerating layer 741 and the second electron accelerating layer 742 may be formed of any material that can generate an electron beam by accelerating electrons, such as oxidized porous silicon. The oxidized porous silicon may be, for example, oxidized porous polysilicon or oxidized porous amorphous silicon.

When a voltage is applied to the first electrode 731 and the third electrode 733 (and/or the second electrode 732), the first electron accelerating layer 741 emits a first electron beam E₁-beam into the cell 714. When a voltage is applied to the second electrode 732 and the fourth electrode 734 (and/or the first electrode 731), the second electron accelerating layer 742 emits a second electron beam E₂-beam into the cell 714. An alternating current applied between the first electrode 731 and the second electrode 732 causes the first electron beam and the second electron beam to be alternately emitted into the cell 714. The first electron beam and the second electron beam excite the gas, which generates ultraviolet rays that in turn excite the light emitting layer 715. The first electron beam and the second electron beam may have an energy greater than the energy required to excite the gas but less than the energy required to ionize the gas.

The third electrode 733 and the fourth electrode 734 may be formed in a mesh structure so that electrons accelerated by the first electron accelerating layer 741 and the second electron accelerating layer 742 can be readily emitted into the cells 714. The first electron accelerating layer 741 and the second electron accelerating layer 742 may serve to form the cells 714 by defining a space between the first substrate 710 and the second substrate 720. At least one spacer (not shown) may further be formed between the first substrate 710 and the second substrate 720.

The voltage waveforms shown in FIG. 9A and FIG. 9B may be applied to the electrodes of the flat lamp shown in FIG. 14 in the same manner as described above.

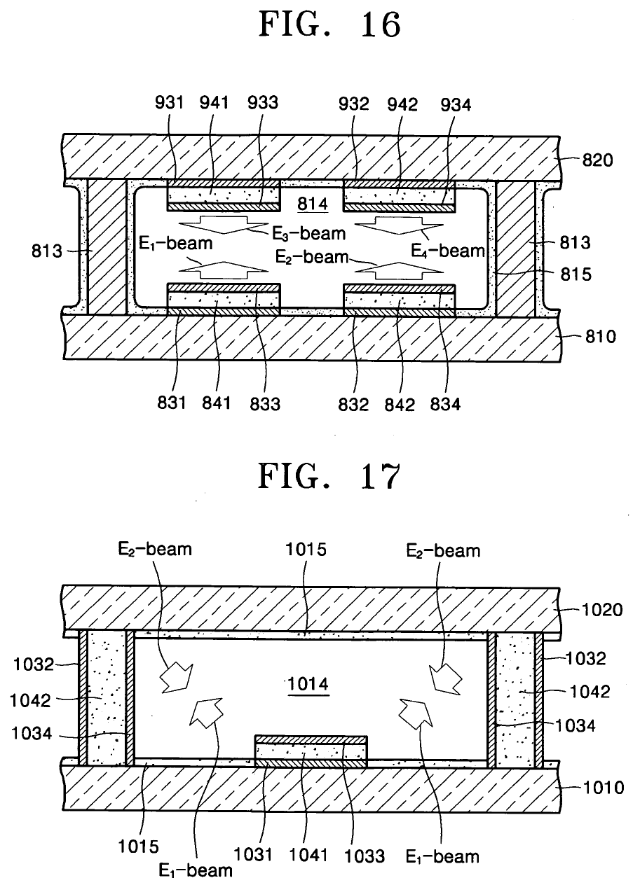

FIG. 15 shows a cross-sectional view of a flat lamp according to an eighth exemplary embodiment of the present invention.

Referring to FIG. 15, a first substrate 810 serves as a lower substrate, and a second substrate 820 serves as an upper substrate. Alternatively, the first substrate 510 may be the upper substrate and the second substrate 520 may be the lower substrate. The first substrate 810 and the second substrate 820 are arranged opposite each other to define at least one cell 814 between them. Spacers 813 may be formed between the first substrate 810 and the second substrate 820 to define at least one cell 814. A light emitting layer 815 is coated on the inner walls of the cell 814, and a gas that includes Xe fills the cell 814.

A first electrode 831 and a second electrode 832 are formed on the upper surface of the first substrate 810 in each cell 814. A first electron accelerating layer 841 and a second electron accelerating layer 842 are formed on the upper surfaces of the first electrode 831 and the second electrode 832, respectively. A third electrode 833 and a fourth electrode 834 are formed on the first electron accelerating layer 841 and the second electron accelerating layer 842, respectively. The first electron accelerating layer 841 and the second electron accelerating layer 842 may be formed of any material that can generate an electron beam by accelerating electrons, such as oxidized porous silicon. The oxidized porous silicon may be, for example, oxidized porous polysilicon or oxidized porous amorphous silicon.

When a voltage is applied to the first electrode 831 and the third electrode 833 (and/or the second electrode 832), the first electron accelerating layer 841 emits a first electron beam E₁-beam into the cell 814. When a voltage is applied to the second electrode 832 and the fourth electrode 834 (and/or the first electrode 831), the second electron accelerating layer 842 emits a second electron beam E₂-beam into the cell 814. An alternating current applied between the first electrode 831 and the second electrode 832 causes the first electron beam and the second electron beam to be alternately emitted into the cell 814. The first electron beam and the second electron beam excite the gas, which generates ultraviolet rays that in turn excite the light emitting layer 815. The first electron beam and the second electron beam may have an energy greater than the energy required to excite the gas but less than the energy required to ionize the gas.

The third electrode 833 and the fourth electrode 834 may be formed in a mesh structure so that electrons accelerated by the first electron accelerating layer 841 and the second electron accelerating layer 842 can be readily emitted into the cell 814.

The voltage waveforms shown in FIG. 9A and FIG. 9B may be applied to the electrodes of the flat lamp shown in FIG. 15 in the same manner as described above.

FIG. 16 shows a cross-sectional view of a flat lamp according to a ninth exemplary embodiment of the present invention.

Referring to FIG. 16, electrodes are formed on the first substrate 810 and also on the second substrate 820. The differences between this exemplary embodiment and the previously described exemplary embodiments will be described.

A fifth electrode 931 and a sixth electrode 932 are formed on the lower surface of the second substrate 820 in each cell 814. The fifth electrode 931 and the sixth electrode 932 are formed parallel to the first electrode 831 and the second electrode 832. The third electron accelerating layer 941 and the fourth electron accelerating layer 942 are formed on the lower surfaces of the fifth electrode 931 and the sixth electrode 932, respectively. The seventh electrode 933 and the eighth electrodes 934 are formed on the lower surfaces of the third electron accelerating layer 941 and the fourth electron accelerating layer 942, respectively. The third electron accelerating layer 941 and the fourth electron accelerating layer 942 may be formed of any material that can generate an electron beam by accelerating electrons, such as oxidized porous silicon. The oxidized porous silicon may be, for example, oxidized porous polysilicon or oxidized porous amorphous silicon.

When a voltage is applied to the fifth electrode 931 and the seventh electrode 933 (and/or the sixth electrode 932), the third electron accelerating layer 941 emits a third electron beam E₃-beam into the cell 814. When a voltage is applied to the sixth electrode 932 and the eighth electrode 934 (and/or the fifth electrode 931), the fourth electron accelerating layer 942 emits a fourth electron beam E₄-beam into the cell 814. An AC voltage applied between the fifth electrode 931 and the sixth electrode 932 causes the third electron beam and the fourth electron beam to be alternately emitted into the cell 814. The seventh electrode 933 and the eighth electrode 934 may be formed in a mesh structure so that electrons accelerated by the third electron accelerating layer 941 and the fourth electron accelerating layer 942 can be readily emitted into the cell 914.

FIG. 17 is a cross-sectional view of a flat lamp according to a tenth exemplary embodiment of the present invention.

Referring to FIG. 17, a first substrate 1010 and a second substrate 1020 are arranged opposite each other with a constant distance between them. At least one cell 1014 is formed between the first substrate 1010 and the second substrate 1020. A light emitting layer 1015 is coated on the inner walls of the cell 1014, and a gas that includes Xe fills the cell 1014.

One first electrode 1031 and two second electrodes 1032 are formed in each of the cells 1014. The second electrodes 1032 are arranged on both sides of the cells 1014. The first electrode 1031 is arranged on an upper surface of the first substrate 1010.

A first electron acceleration layer 1041 and a second electron acceleration layer 1042 are formed on the inner surface of the first electrode 1031 and the second electrode 1032, respectively. A third electrode 1033 and a fourth electrode 1034 are formed on the first electron acceleration layer 1041 and the second electron acceleration layer 1042, respectively. The first electron acceleration layer 1041 and the second electron accelerating layer 1042 may be formed of any material that can generate an electron beam by accelerating electrons, such as oxidized porous silicon. The oxidized porous silicon may be, for example, oxidized porous polysilicon or oxidized porous amorphous silicon.

When a predetermined voltage is applied to the first electrode 1031 and the third electrode 1033 (and/or the second electrode 1032), the first electron accelerating layer 1041 emits a first electron beam E₁-beam into the cell 1014. When a predetermined voltage is applied to the second electrode 1032 and the fourth electrode 1034 (and/or the first electrode 1031), the second electron accelerating layer 1042 emits a second electron beam E₂-beam into the cell 1014. An AC voltage applied between the first electrode 1031 and the second electrode 1032 causes the first electron beam and the second electron beam to be alternately emitted into the cell 1014. The first electron beam and the second electron beam excite the gas, which generates ultraviolet rays that in turn excite the light emitting layer 1015. The first and second electron beams may have energy levels that are greater than the energy required to excite the gas but smaller than the energy required to ionize the gas.

The third electrode 1033 and the fourth electrode 1034 may be formed in a mesh structure to allow electrons accelerated by the first electron accelerating layer 1041 and the second electron accelerating layer 1042 to be readily emitted into the cells 1014. The second electron accelerating layers 1042 serve to form the cells 1014 by defining a space between the first substrate 1010 and the second substrate 1020. At least one spacer (not shown) may further be formed between the first substrate 1010 and the second substrate 1020.

The voltage waveforms shown in FIG. 9A and FIG. 9B can be applied to the electrodes of the flat lamp shown in FIG. 17 in the same manner as described above.

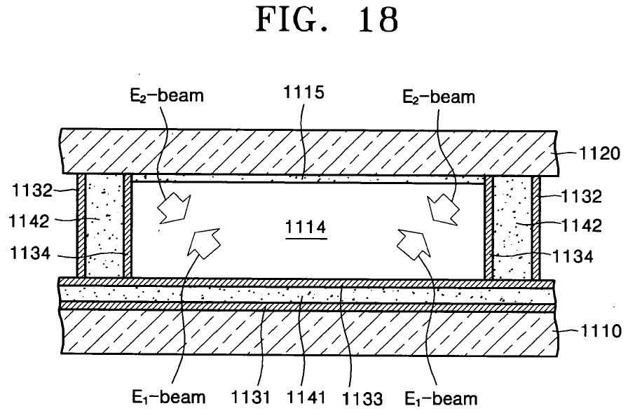

FIG. 18 shows a cross-sectional view of a flat display device according to an eleventh exemplary embodiment of the present invention.

Referring to FIG. 18, a first substrate 1110 and a second substrate 1120 are arranged opposite each other with a constant distance between them. A plurality of cells 1114 are formed between the first substrate 1110 and the second substrate 1120. Red, green, and blue light emitting layers 1115 are coated on inner walls of the cells 1114, and a gas that may include Xe fills the cells 1114.

One first electrode 1131 and two second electrodes 1132 are formed in each of the cells 1114 between the first substrate 1110 and the second substrate 1120. The first electrode 1131 is arranged on an upper surface of the first substrate 1110, and the second electrodes 1132 are arranged on both sides of each of the cells 1114. The first electrode 1131 and the second electrodes 1132 extend to cross each other.

A first electron acceleration layer 1141 and a second electron acceleration layer 1142 are formed on the inner surfaces of the first electrode 1131 and the second electrode 1132, respectively. A third electrode 1133 and a fourth electrode 1134 are formed on the first electron acceleration layer 1141 and the second electron acceleration layer 1142, respectively. The first electron acceleration layer 1141 and the second electron acceleration layer 1142 may be formed of any material that can generate an electron beam by accelerating electrons, such as oxidized porous silicon. The oxidized porous silicon may be, for example, oxidized porous polysilicon or oxidized porous amorphous silicon.

When a voltage is applied to the first electrode 1131 and the third electrode 1133 (and/or the second electrode 1132), the first electron accelerating layer 1141 emits a first electron beam E₁-beam into the cell 1114. When a voltage is applied to the second electrode 1132 and the fourth electrode 1134 (or the first electrode 1131), the second electron accelerating layers 1142 emit two second electron beams E₂-beam into the cell 1114. An AC voltage applied between the first electrode 1131 and the second electrode 1132 cause the first electron beam and the second electron beams to be alternately emitted into the cell 1114. The first electron beam and the second electron beams excite the gas, and the gas generates ultraviolet rays, which in turn excite the light emitting layer 1115. The first electron beam and the second electron beams may have energy levels that are greater than the energy required to excite the gas but smaller than the energy required to ionize the gas.

The third electrode 1133 and the fourth electrode 1134 may be formed in a mesh structure to allow the electrons accelerated by the first electron accelerating layer 1141 and the second electron accelerating layers 1142 to be easily emitted into the cells 1114. The second electron accelerating layers 1142 serve to form the cells 1114 by defining a space between the first substrate 1110 and the second substrate 1120. A plurality of barrier ribs (not shown) may be further formed between the first substrate 1110 and the second substrate 1120.

The voltage waveforms shown in FIG. 9A and FIG. 9B may be applied to the electrodes of the flat display device shown in FIG. 18 in the same manner as described above.

It will be apparent to those skilled in the art that various modifications and variation can be made in the present invention without departing from the spirit or scope of the invention. Thus, it is intended that the present invention cover the modifications and variations of this invention provided they come within the scope of the appended claims and their equivalents.

What is claimed is:

1. A display device, comprising:
a first substrate and a second substrate opposing each other and having a space between them;
a cell positioned between the first substrate and the second substrate;
a first electrode positioned to correspond to the cell;
a second electrode positioned to correspond to the cell;
a first electron accelerating layer positioned on the first electrode and being capable of emitting a first electron beam into the cell;
a gas inside the cell and being capable of generating ultraviolet rays when excited by the first electron beam; and
a light emitting layer positioned inside the cell and being capable of generating visible light when excited by the ultraviolet rays.

2. The display device of claim 1, further comprising:
a third electrode positioned on the first electron accelerating layer.

3. The display device of claim 2,
wherein V₁<V₃<V₂, where V₁ is the voltage applied to the first electrode, V₂ is the voltage applied to the second electrode, and V₃ is the voltage applied to the third electrode.

4. The display device of claim 3,
wherein the second electrode is grounded.

5. The display device of claim 2,
wherein V₁<V₂=V₃, where V₁ is the voltage applied to the first electrode, V₂ is the voltage applied to the second electrode, and V₃ is the voltage applied to the third electrode.

6. The display device of claim 5,
wherein the second electrode and the third electrode are grounded.

7. The flat display device of claim 2,
wherein at least one of the second electrode or the third electrode has a mesh structure.

8. The display device of claim 1,
wherein no first electrode is positioned on the same interior surface of the cell as a second electrode.

9. The display device of claim 8,
wherein the first electrode is positioned on the first substrate and the second electrode is positioned on the second substrate.

10. The display device of claim 1,
wherein the first electrode is positioned on the same interior surface of the cell as the second electrode.

11. The display device of claim 1, further comprising:
a second electron accelerating layer positioned on the second electrode and being capable of emitting a second electron beam into the cell.

12. The display device of claim 11,
wherein the first electrode and the second electrode are driven by an AC voltage.

13. The display device of claim 11, further comprising:
a third electrode positioned on the first electron acceleration layer; and
a fourth electrode positioned on the second electron acceleration layer.

14. The display device of claim 13,
wherein V₁<V₃ and V₂<V₄, where V₁ is the voltage applied to the first electrode, V₂ is the voltage applied to the second electrode, V₃ is the voltage applied to the third electrode, and V₄ is the voltage applied to the fourth electrode.

15. The display device of claim 14,
wherein the third electrode and the fourth electrode are grounded.

16. The display device of claim 13,
wherein the third electrode and the fourth electrode have mesh structures.

17. The display device of claim 13,
wherein no first electrode is positioned on the same interior surface of the cell as a second electrode.

18. The display device of claim 17,
wherein the first electrode is positioned on the first substrate and the second electrode is positioned on the second substrate.

19. The display device of claim 17,
wherein either the first electrode or the second electrode is disposed on the first substrate or the second substrate, and
wherein whichever of the first electrode or the second electrode that is not disposed on the first substrate or second substrate is disposed on at least one of the side walls of the cell.

20. The display device of claim 17,
wherein the first electrode and the second electrode are positioned on opposite sides of the side walls of the cell.

21. The display device of claim 13,
wherein the first electrode is positioned on the same interior surface of the cell as the second electrode.

22. The display device of claim 21, further comprising:
a fifth electrode positioned on the inside surface of the cell that is opposite of the first electrode and the second electrode;
a sixth electrode positioned on the same surface as the fifth electrode;
a third electron accelerating layer positioned on the fifth electrode and being capable of emitting a third electron beam into the cell;
a fourth electron accelerating layer positioned on the sixth electrode and being capable of emitting a fourth electron beam into the cell;
a seventh electrode positioned on the third electron acceleration layer; and
an eighth electrode positioned on the fourth electron acceleration layer.

23. The display device of claim 13, further comprising:
an address electrode that extends to cross the first electrode and the second electrode.

24. The display device of claim 23, further comprising:
a dielectric layer that covers the address electrode.

25. The display device of claim 1,
wherein the energy level of the first electron beam is greater than the energy required to excite the gas and smaller than the energy required to ionize the gas.

26. The display device of claim 1,
wherein the first electron acceleration layer includes oxidized porous silicon.

27. The display device of claim 26,
wherein the oxidized porous silicon is oxidized porous polysilicon or oxidized porous amorphous silicon.

28. The display device of claim 1, further comprising:
a dielectric layer covering the second electrode.

29. The display device of claim 1,
wherein the gas includes Xe.

30. The display device of claim 29,
wherein the energy level of the first electron beam is about 8.28 eV to about 12.13 eV.

31. The display device of claim 30,
wherein the energy level of the first electron beam is about 8.28 eV to about 9.57 eV.

32. The display device of claim 31,
wherein the energy level of the first electron beam is about 8.28 eV to about 8.45 eV.

33. The display device of claim 31,
wherein the energy level of the first electron beam is about 8.45 eV to about 9.57 eV.

34. The display device of claim 1,
wherein the first electrode and the second electrode extend to cross each other.
